(19) United States
(12) Patent Application Publication
(10) Pub. No.: US 2011/0292069 A1
(43) Pub. Date: Dec. 1, 2011

(54) RGB Color Mixer

(76) Inventor: David Joseph WITT, San Francisco, CA (US)

(21) Appl. No.: 12/861,023

(22) Filed: Aug. 23, 2010

Related U.S. Application Data
(60) Provisional application No. 61/349,241, filed on May 28, 2010.

(51) Int. Cl. G09G 5/02

(52) U.S. Cl. 345/590

(57) ABSTRACT

A computer based color mixer interface allowing users to manipulate Red, Green, and Blue channels individually or in combination to create a color. The interface manipulates colors in a way that allows users to better visualize and perceive changes in color relationship for creation of different colors. This enables the user to make better color choices.

The current application claims a priority to the U.S. Provisional Patent application Ser. No. 61/349,241 filed on May 28, 2010.

### FIELD OF THE INVENTION

The present invention relates generally to a software application for adjusting and visualizing RGB color values. It is the objective of the present invention to allow users to mix RGB colors by manipulating the constituent color channels.

### BACKGROUND OF THE INVENTION

In computer-based design, color selection can be a difficult task, due to both the amount of possible color choices, and the fact that the presence and amount of one color can affect the perception of adjacent colors in the final composition. The present invention introduces a color mixer interface that manipulates Red, Green and Blue color channels alone, and in combination, to mix the resulting composite color. By employing the interface within the context of a graphical layout, the user is able to better perceive minute changes in color relationships, and make finer-grained color changes. Using applied color theory along with the color mixer interface, the operator is able to make more intelligent color choices.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

FIG. 1 is a diagram of the present invention with the one or more graphic element in an array of small squares.

FIG. 2 is a diagram of the present invention with the one or more graphic element in an array of squares.

FIG. 3 is a diagram of the present invention with the one or more graphic element as concentric squares.

FIG. 4 is a diagram of the present invention with the one or more graphic element as thin triangles fanning about the center in all directions.

FIG. 5 is a diagram of the present invention demonstrating proportional dual channel sliding in relation to FIG. 6.

FIG. 6 is a diagram of the present invention demonstrating proportional dual channel sliding in relation to FIG. 5.

FIG. 7 is a diagram of the present invention demonstrating maintenance of unequal position of sliders for shading in relation to FIG. 8 and FIG. 9.

FIG. 8 is a diagram of the present invention demonstrating maintenance of unequal position of sliders for shading in relation to FIG. 7 and FIG. 9.

FIG. 9 is a diagram of the present invention demonstrating maintenance of unequal position of sliders for shading in relation to FIG. 7 and FIG. 9.

### DETAIL DESCRIPTIONS OF THE INVENTION

All illustrations of the drawings are for the purpose of describing selected versions of the present invention and are not intended to limit the scope of the present invention.

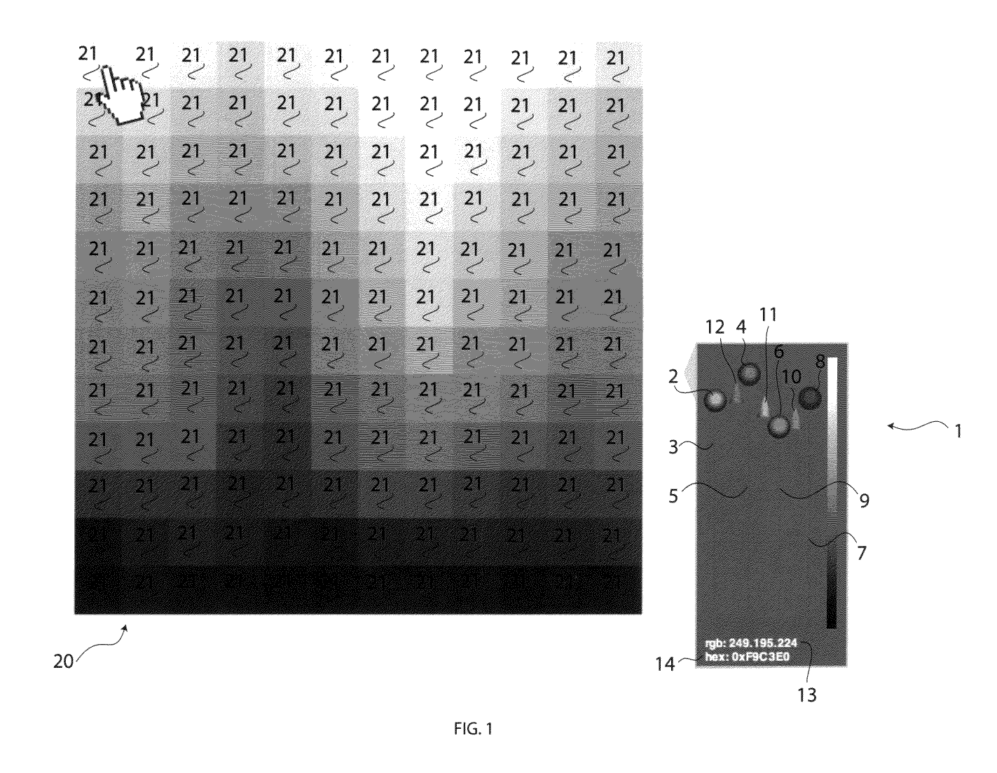

The present invention is a color mixing interface that allows users to mix and compare different colors within the context of a graphic layout 20. In reference to FIG. 1-9, the present invention comprises of a color mixer interface 1 used in conjunction with the generic sample graphic layout 20. The color mixer interface 1 allows user interaction for adjusting and mixing colors desired for the elements within the graphic layout 20. The color mixer interface 1 comprises of a grayscale tri-channel slider 2, gray scale reference bar 3, a Red channel slider 4, a Red scale bar 5, a Green channel slider 6, a Green scale bar 7, a Blue channel slider 8, a Blue scale bar 9, a Blue-Green dual channel slider 10, a Red-Green dual channel slider 11, a Red-Blue dual channel slider 12, a RGB value indicator 13, and a hex code value indicator 14. The grayscale tri-channel slider 2 is positioned on the gray scale reference bar 3. As the grayscale tri-channel slider 2 is maneuvered and adjusted, the Red channel slider 4, the Green channel slider 6, and the Blue channel slider 8 are equalized, producing a range of neutral gray color values from Black to White. The Red channel slider 4 is positioned on the Red scale bar 5. As the Red channel slider 4 is maneuvered and adjusted on the Red scale bar 5, the position of the Red channel slider 4 relates to the amount of Red in the resulting composite color value. The Red scale possesses a range of 256 possible values, from 0 to 255, with the bottom of the scale corresponding to 0. The Green channel slider 6 is positioned on the Green scale bar 7. As the Green channel slider 6 is maneuvered and adjusted on the Green scale bar 7, the position of the Green channel slider 6 relates to the amount of Green in the resulting composite color value. The Green scale possesses a range of 256 possible values, from 0 to 255, with the bottom of the scale corresponding to 0. The Blue channel slider 8 is positioned on the Blue scale bar 9. As the Blue channel slider 8 is maneuvered and adjusted on the Blue scale bar 9, the position of the Blue channel slider 8 relates the scale of Blue. The Blue scale 9 possesses a range of 256 possible values, from 0 to 255, with the bottom of the scale corresponding to 0. The Blue-Green dual-channel slider 10 is located between the Blue channel slider 8 and the Green channel slider 6. The Blue-Green dual-channel slider 10 links the Blue channel slider 8 and the Green channel slider 6 together. In the base configuration, by selecting the Blue-Green dual-channel slider 10, the Blue channel slider 8 and the Green channel slider 6 are automatically equalized to the same scale value. The adjustments to the Blue-Green dual-channel slider 10 will simultaneously adjust the Blue channel slider 8 and the Green channel slider 6 in equal amounts, which is the equivalent of adding or subtracting the color Cyan from the composite RGB value. The Red-Green dual channel slider 11 is located between the Red channel slider 4 and the Green channel slider 6. The Red-Green dual-channel slider 11 links the Red channel slider 4 and the Green channel slider 6 together. In the base configuration, by selecting the Red-Green dual channel slider 11, the Red channel slider 4 and the Green channel slider 6 are automatically equalized to the same scale value. The adjustments to the Red-Green dual channel slider 11 will simultaneously adjust the Red channel slider 4 and the Green channel slider 6 in equal amounts, which is the equivalent of adding or subtracting the color Yellow from the final composite RGB color value. The Red-Blue dual channel slider 12 is positioned between the grayscale tri-channel slider 2 and the Red channel slider 4. The Red-Blue dual channel slider 12 links the Red channel slider 4 and the Blue channel slider 8 together. In the base configuration, by selecting the Red-Blue dual channel slider 12, the Red channel slider 4 and the Blue channel slider 8 are automatically equalized to the same scale value. The adjustments to the Red-Blue dual channel slider 12 will simultaneously adjust the Red channel slider 4 and the Blue channel slider 8 in equal amounts, which is the equivalent of adding or subtracting the color Magenta from the final composite RGB color value. As the sliders are adjusted, the scale numbers are reflected on the RGB value indicator 13. The RGB value indicator 13 displays the composite RGB color value of the Red channel slider 4, the Green channel slider 6, and the Blue channel slider 8. The values displayed for each slider can range from 0 to 255, for 24-bit color, display also known as ‘True Color’ because it is the closest display approximation of the full range of human color perception. There are 16,777,216 possible 24-bit color values (256×256×256).

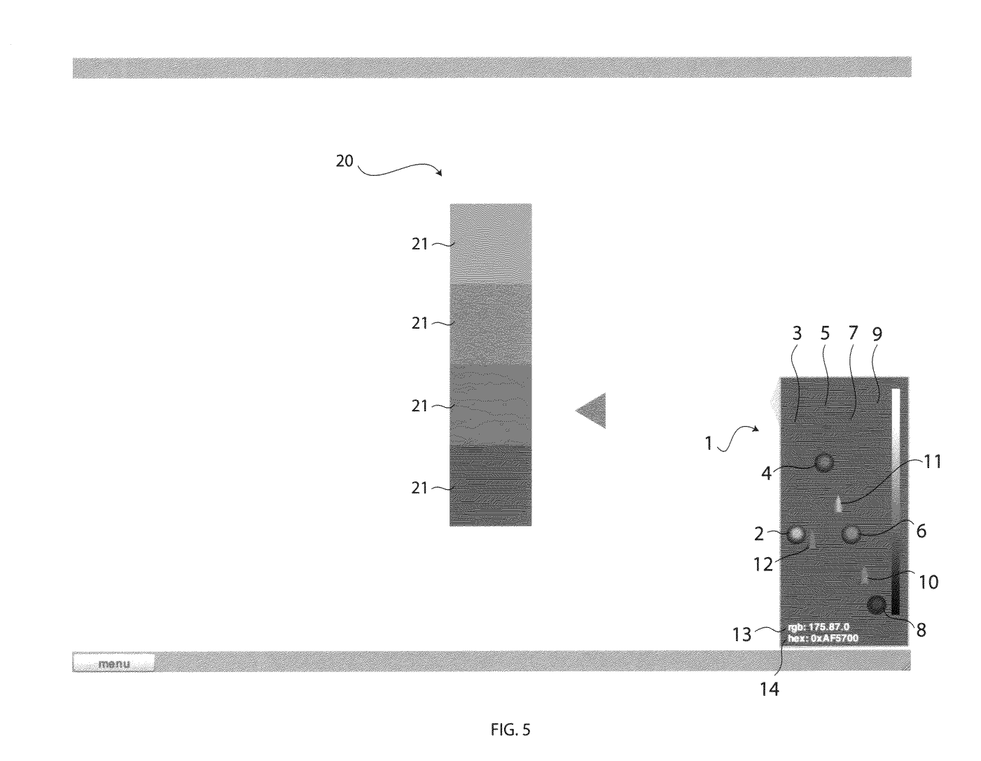

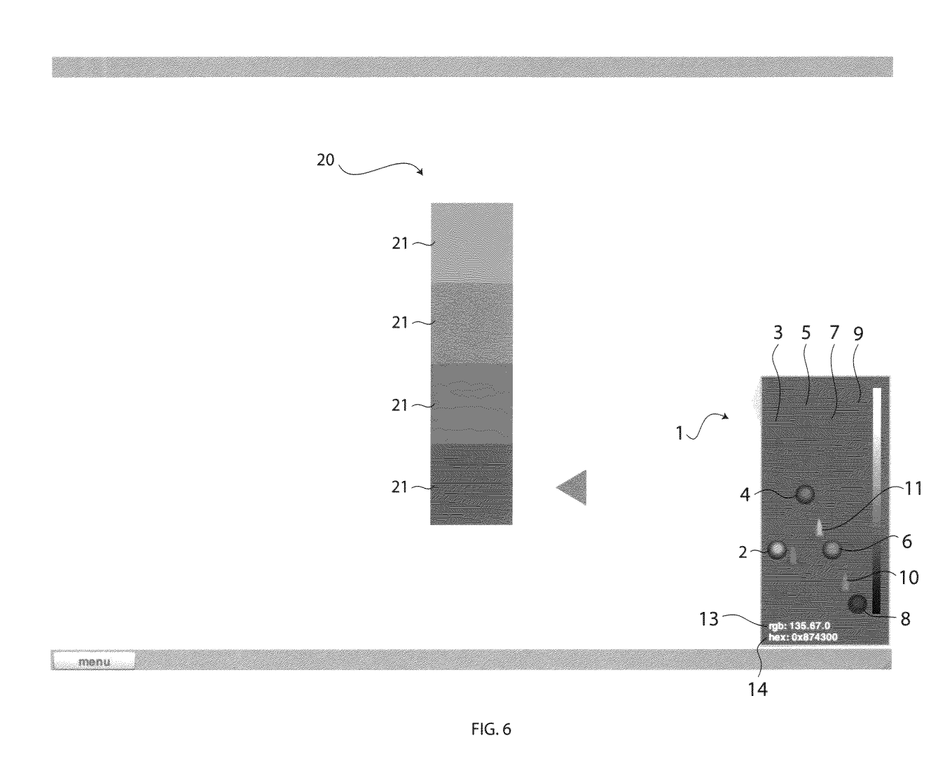

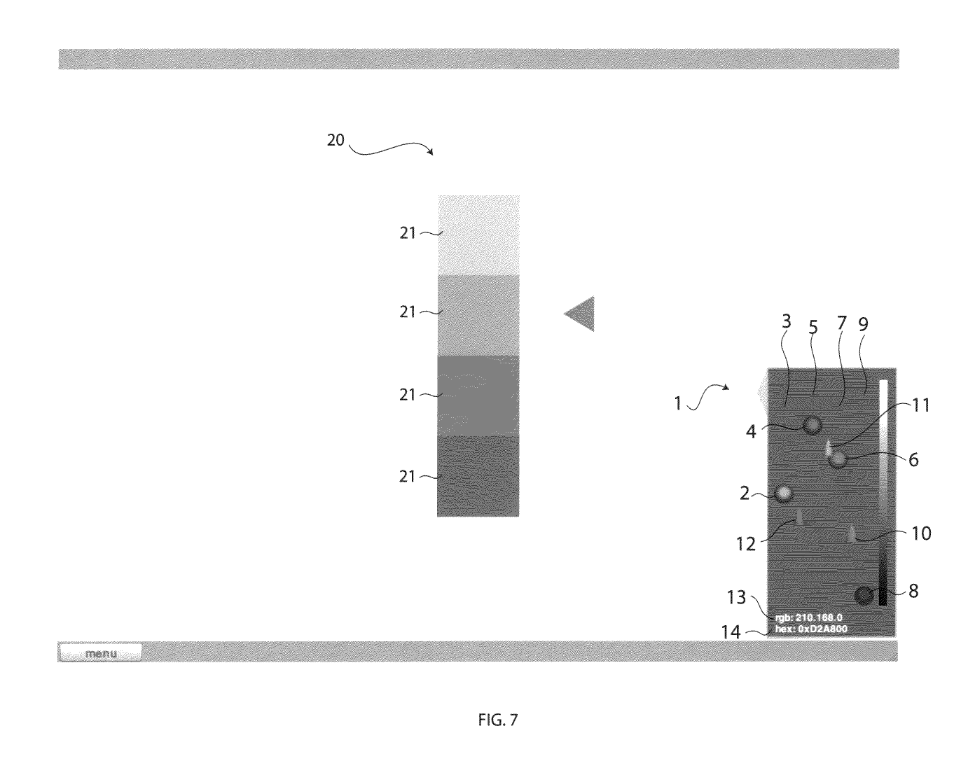

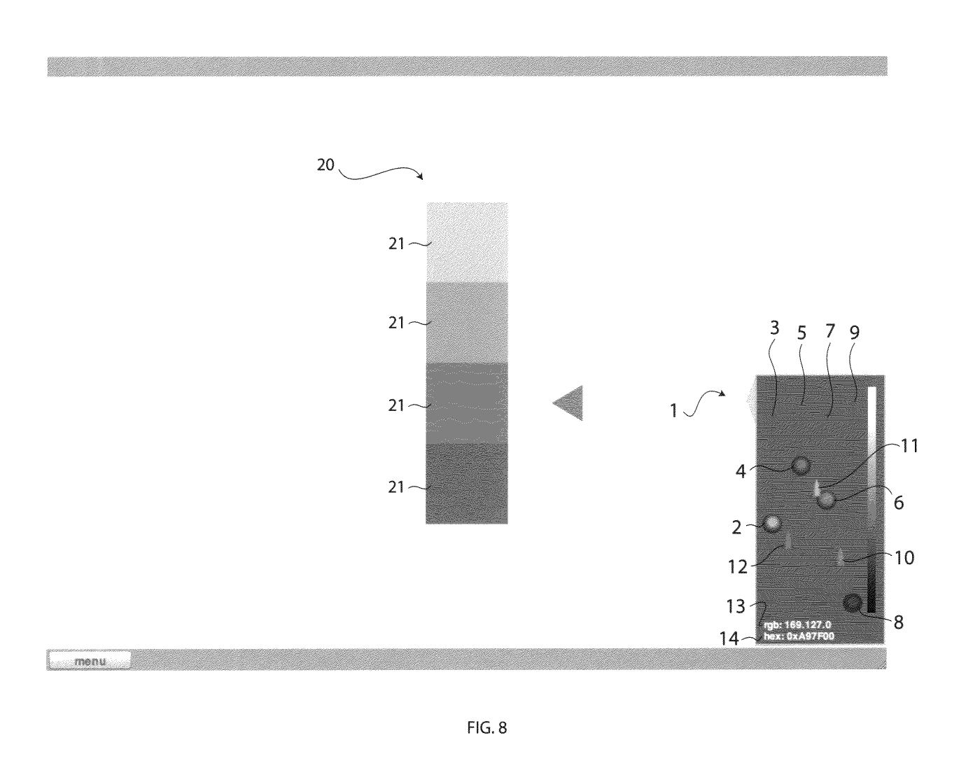

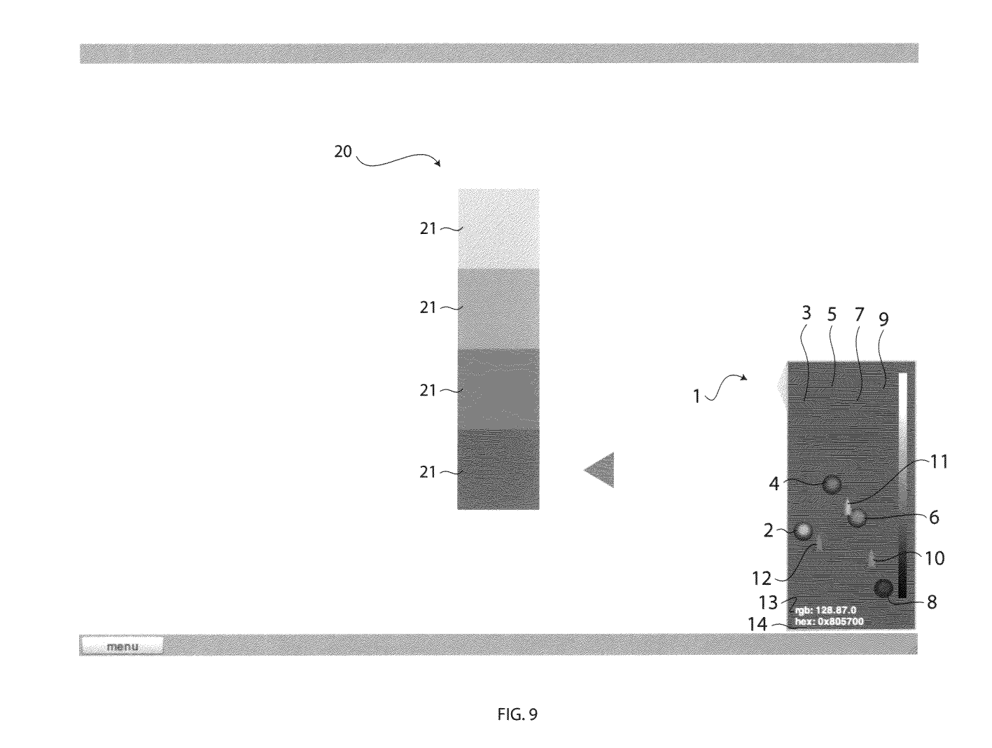

In another embodiment of the present invention, selecting the dual-channel slider does not equalize the positions of the sliders. Instead, the relative position of the sliders for each channel is maintained as the Red-Green, Green-Blue, and Red-Blue dual channel sliders are moved along the scale. In reference to FIG. 5-9, the dual channel sliders can be used to maintain proportions between two channels or used to maintain the same unequal positioned between two channels. FIG. 5 and FIG. 6 show a tint strip of four shades of Orange and shows an example of maintaining proportion. Moving down the tint strip, the color mixer interface 1 shows the relationship between the Red channel slider 4 and the Green channel slider 6 being maintained at the same proportion with the Green channel slider 6 being half value of the Red channel slider 4. FIG. 7, FIG. 8, and FIG. 9 show the tint strip of four shades of Yellow and shows an example of maintaining unequal positioning between two color channels. Moving down the tint strip, the color mixer interface 1 shows the relationship between the Red channel slider 4 and the Green channel slider 6 being maintained with equal differences in value.

The Red, Green, and Blue values taken together form a composite RGB color value. Since computer systems use hexadecimal values rather than decimal, the scale value of the sliders must be first converted from decimal to hexadecimal. 24-bit RGB values consist of the three color channel values concatenated together, where RR is the Red value, GG is the Green value, BB is the Blue value, and is proceeded by a hex identifier of either ‘0x’ or ‘#’, producing a hexadecimal value in the following format:

0xRRGGBB or #RRGGBB

The present invention uses a look up table consisting of an array containing the 256 possible hexadecimal number values available for each color slider, from 00 to FF. The hex number for each color channel is taken from the array position matching the numeric position of the Red channel slider 4, the Green channel slider 6, and the Blue channel slider 8 value on the slider range. For example, if the position of a slider is at the lowest point of the slider scale, the value is 0 and the corresponding hex value is 00. If the slider position is at the highest position of the slider scale, the value is 255 and the corresponding hex value is FF. The converted hexadecimal values are displayed under the RGB value indicator 13 by the hex code value indicator 14.

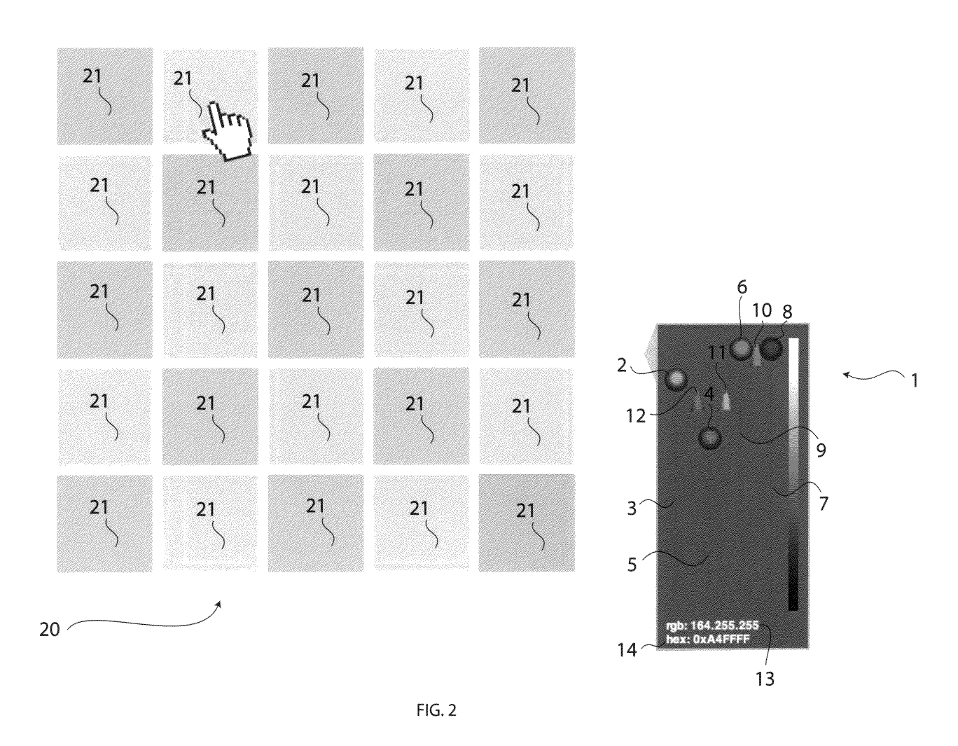

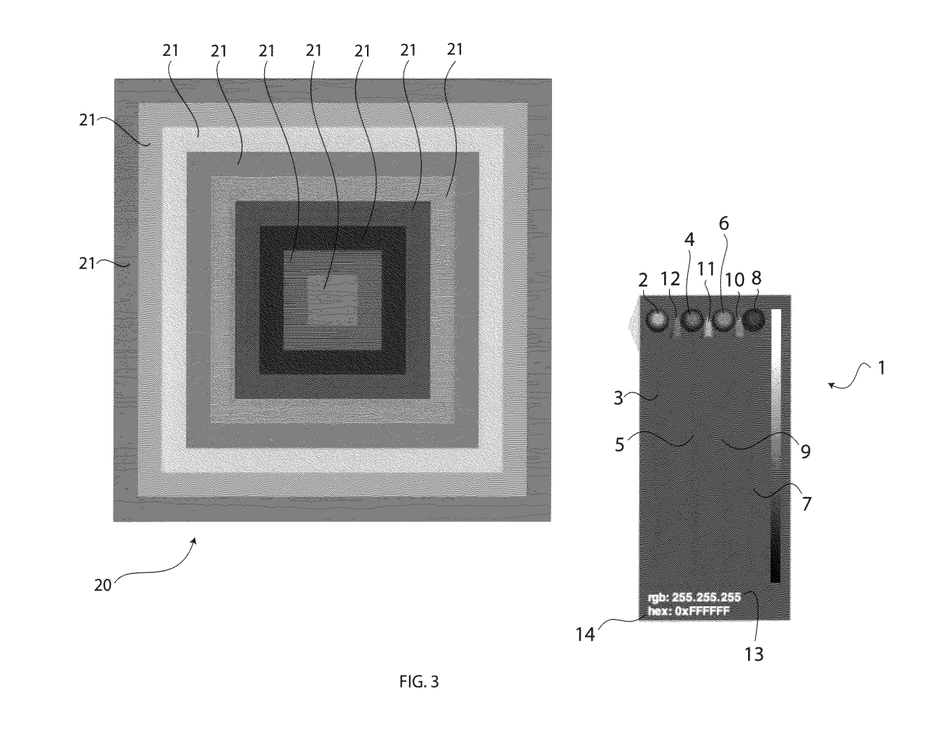

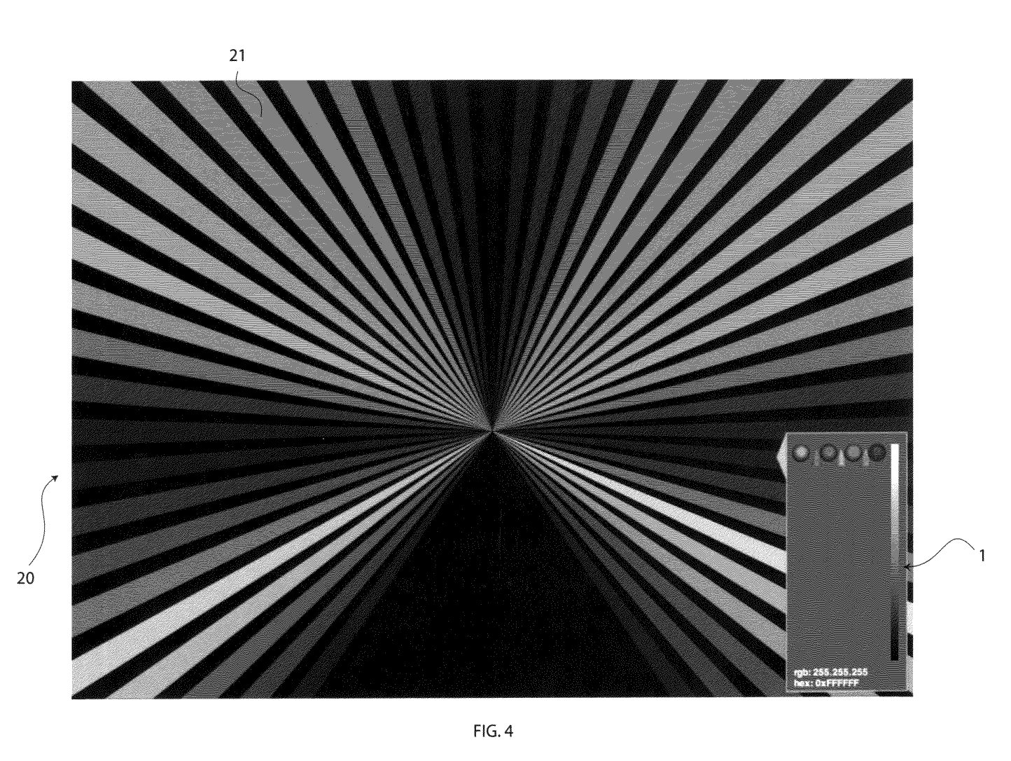

In reference to FIG. 2, the color mixer interface 1 is used in conjunction with a graphic layout 20, which consists of one or more graphic element 21. The one or more graphic element 21 is non-photographic, such as shapes, lines, and text. FIG. 3 and FIG. 4 show different types of non-photographics that the one or more graphic element can embody. The color mixer interface 1 is used to adjust the color values of the one or more graphic element 21 within the context of the graphic layout 20, implemented as a floating palette, rather than a modal dialog, in real time. The colors will change and the corresponding color values are updated continuously as the user manipulates the sliders. Each graphic element of the graphic layout 20 can be selected individually or in groups for adjustment of color values simultaneously.

The physical color display output includes all RGB-based computer displays, as well as Light Emitting Diode (LED) ‘Pixel Lights’, which are defined as a physical grouping consisting of one Red, one Green and one Blue diode. In this case, the color mixer interface 1 is used to manipulate the voltage supply to each individual diode within the grouping. The color mixer interface 1 may be used in the manner described previously to control a display consisting of one or more Pixel Lights.

Although the invention has been explained in relation to its preferred embodiment, it is to be understood that many other possible modifications and variations can be made without departing from the spirit and scope of the invention as hereinafter claimed.

What is claimed is:

1. A RGB color mixer comprises,
a color mixer interface;
a graphic layout;
the color mixer interface comprises a grayscale tri-channel slider, a grayscale reference bar, a Red channel slider, a Red scale bar, a Green channel slider, a Green scale bar, a Blue channel slider, a Blue scale bar, a Blue-Green dual channel slider, a Red-Green dual channel slider, a Red-Blue dual channel slider, a RGB value indicator, and a hex color code indicator; and
the graphic layout being the area of the present invention alongside or underneath the color mixer interface;
the graphic layout comprises of one or more graphic element.

2. The RGB color mixer as claimed in claim 1 comprises,
the grayscale tri-channel slider being positioned on the grayscale reference bar;
the Red channel slider being positioned on the Red scale bar;
the Green channel slider being positioned on the Green scale bar;
the Blue channel slider being positioned on the Blue scale bar;

3. The RGB color mixer as claimed in claim 1 comprises,
the Blue-Green dual channel slider being positioned between the Blue channel slider and the Green channel slider;
the Red-Green dual channel slider being positioned between the Red channel slider and the Green channel slider;
the Red-Blue dual channel slider being positioned between the Red channel slider and the grayscale tri-channel slider;
the RGB value indicator being positioned below the Red scale bar, the Green scale bar, the Blue scale bar, and the gray scale reference bar;
the hex code indicator being positioned below the Red scale bar, the Green scale bar, the Blue scale bar, and the gray scale reference bar;

4. The RGB color mixer as claimed in claim 1 comprises,
the one or more graphic element selected from the group, being non-photographic, and consisting of shapes, lines, or text; and
the one or more graphic element displaying the color determined by the positioning and values of the Red channel slider, the Green channel slider, and the Blue channel slider.

5. The RGB color mixer as claimed in claim 3 comprises,
the Blue-Green dual channel slider linking the Blue channel slider and the Green channel slider;
the Red-Green dual channel slider linking the Red channel slider and the Green channel slider;
the Red-Blue dual channel slider linking the Red channel slider and the Blue channel slider; and
the grayscale tri-channel slider linking the Red channel slider, the Green channel slider, and the Blue channel slider.

6. The RGB color mixer as claimed in claim 5 comprises,
the Blue-Green dual channel slider being able to equalize the Blue channel slider and the Green channel slider for simultaneous adjustment of equal values in both channels;
the Red-Green dual channel slider being able to equalize the Red channel slider and the Green channel slider for simultaneous adjustment of equal values in both channels;
the Red-Blue dual channel slider being able to equalize the Red channel slider and the Blue channel slider for simultaneous adjustment of equal values in both channels; and
the grayscale tri-channel slider being able to equalize the Red channel slider, the Green channel slider, and the Blue channel slider for simultaneous adjustment of equal values in all three channels.

7. The RGB color mixer as claimed in claim 5 comprises,
the Blue-Green dual channel slider being able to proportionally adjust the Blue channel slider and the Green channel slider simultaneously for different values of a Blue-Green color set by the user;
the Red-Green dual channel slider being able to proportionally adjust the Red channel slider and the Green channel slider simultaneously for different values of a Red-Green color set by the user;
the Red-Blue dual channel slider being able to proportionally adjust the Red channel slider and the Blue channel slider simultaneously for different values of a Red-Blue color set by the user; and
the grayscale tri-channel slider being able to proportionally adjust the Red channel slider, the Green channel slider, and the Blue channel slider for different shades of gray set by the user.
